(19) United States
(12) Patent Application Publication
(10) Pub. No.: US 2023/0246232 A1
(43) Pub. Date: Aug. 3, 2023

(54) PRECURSOR COMPOSITION FOR POLYMER ELECTROLYTE AND GEL POLYMER ELECTROLYTE FORMED THEREFROM

(71) Applicants: LG ENERGY SOLUTION, LTD., Seoul (KR); IUCF-HYU (INDUSTRY-UNIVERSITY COOPERATION FOUNDATION HANYANG UNIVERSITY), Seoul (KR)

(72) Inventors: Kyoung Ho AHN, Daejeon (KR); Chul Haeng LEE, Daejeon (KR); Jung Hoon LEE, Daejeon (KR); Dong Won KIM, Yongin-si, Gyeonggi-do (KR); Sung Guk PARK, Daejeon (KR); Bo Ra JEONG, Gwangju (KR); Da Ae LIM, Seoul (KR)

(73) Assignees: LG ENERGY SOLUTION, LTD., Seoul (KR); IUCF-HYU (INDUSTRY-UNIVERSITY COOPERATION FOUNDATION HANYANG UNIVERSITY), Seoul (KR)

(21) Appl. No.: 18/021,992

(22) PCT Filed: Sep. 10, 2021
(86) PCT No.: PCT/KR2021/012364

§ 371 Date: Feb. 17, 2023

(30) Foreign Application Priority Data
Sep. 11, 2020 (KR) 10-2020-0117073
Sep. 9, 2021 (KR) 10-2021-0120342

(51) Int. Cl. H01M 10/0565; H01M 10/052

(52) U.S. Cl. CPC H01M 10/0565; H01M 10/052; H01M 2300/0085

(57) ABSTRACT

The present invention relates to a precursor composition for a polymer electrolyte including two types of crosslinking agents and a gel polymer electrolyte formed therefrom.

### CROSS-REFERENCE TO RELATED APPLICATIONS

This application claims priority from Korean Patent Application Nos. 10-2020-0117073, filed on Sep. 11, 2020, and 10-2021-0120342, filed on Sep. 9, 2021, the disclosure of which is incorporated by reference herein.

### TECHNICAL FIELD

### Technical Field

The present invention relates to a precursor composition for a polymer electrolyte including two types of crosslinking agents and a gel polymer electrolyte including a polymer matrix which is formed therefrom.

### Background Art

Demand for lithium ion batteries (LIBs) with high energy density is rapidly increasing with the technological advancement of mobile electronic devices, electric vehicles (EVs), and grid-scale energy storage systems (ESSs).

A lithium ion battery is largely composed of materials such as a positive electrode composed of a transition metal oxide containing lithium, a negative electrode capable of storing lithium, an electrolyte acting as a medium for transferring lithium ions, and a separator.

A liquid electrolyte having high ionic conductivity and excellent electrochemical properties has been used as the electrolyte of the lithium ion battery. However, since the liquid electrolyte is highly flammable and has high reactivity to the electrode materials, a side reaction may occur, and, since the liquid electrolyte has low stability, for example, occurrence of leakage, fire and explosion may be caused under abnormal operating conditions.

Recently, in order to improve stability of the lithium ion battery, research to develop a more stable electrolyte, instead of the liquid electrolyte, has emerged.

An ionic liquid electrolyte, a solid electrolyte, or a gel polymer electrolyte has been proposed as such an electrolyte.

The ionic liquid electrolyte has improved thermal and oxidative stability, but is disadvantageous in that it is unstable on a surface of the negative electrode, has low wettability to a polyolefin-based separator due to high viscosity, and is expensive.

Since the solid electrolyte excludes a flammable organic solvent, the stability of the battery is significantly improved, but the solid electrolyte is disadvantageous in that ionic conductivity around the electrolyte is reduced, and life characteristics are degraded due to an increase in interfacial resistance between the solid electrolyte and the solid electrode.

The gel polymer electrolyte is a system in which a liquid electrolyte is encapsulated and impregnated in a chemically crosslinked polymer structure, wherein the gel polymer electrolyte is advantageous in that it may not only ensure relatively high ionic conductivity at a reasonable price, but also has high structural, thermal, and mechanical stabilities over time.

However, the gel polymer electrolyte requires a high temperature or strong energy, such as ultraviolet light, to form a crosslink, and, also, a by-product formed during a side reaction or unreacted material becomes a cause of degrading cell characteristics while remaining in the gel polymer electrolyte. Particularly, since the chemically crosslinked polymer structure interferes with movement of lithium ions, the gel polymer electrolyte is disadvantageous in that it is difficult to ensure ionic conductivity equivalent to that of the liquid electrolyte. Accordingly, there is a disadvantage in that the battery stability is reduced because the leakage reoccurs while an amount of organic solvent used is increased in order to ensure high ionic conductivity.

The present invention aims at providing a gel polymer electrolyte which may reduce the amount of the organic solvent used to prevent the leakage and may improve the ionic conductivity at the same time.

### DISCLOSURE OF THE INVENTION

### Technical Problem

An aspect of the present invention provides a precursor composition for a polymer electrolyte which includes two types of crosslinking agents capable of rapidly forming a crosslink at a low temperature.

Another aspect of the present invention provides a gel polymer electrolyte including a polymer matrix which is formed by a thiol-ene click reaction of the precursor composition for a polymer electrolyte.

Another aspect of the present invention provides a lithium secondary battery including the gel polymer electrolyte.

### Technical Solution

According to an aspect of the present invention, there is provided a precursor composition for a polymer electrolyte which includes: a first crosslinking agent formed of a compound containing at least two thiol groups (—SH),

a second crosslinking agent including a compound represented by Formula 2, and

a non-aqueous electrolyte solution containing a lithium salt and an organic solvent.

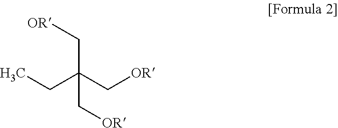

In Formula 2,

R′ is

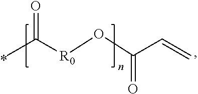

wherein R₀ is an alkylene group having 2 to 8 carbon atoms, and

n is an integer of 1 to 15.

According to another aspect of the present invention, there is provided a gel polymer electrolyte including a polymer matrix which is formed by a thiol-ene click reaction of the precursor composition for a polymer electrolyte of the present invention, and a secondary battery including the same.

### Advantageous Effects

Since a precursor composition for a polymer electrolyte of the present invention includes a first crosslinking agent formed of a compound containing at least two thiol groups (—SH) and a second crosslinking agent formed of a compound represented by Formula 2 containing at least one polymerizable functional group, it may prepare a gel polymer electrolyte including a polymer matrix capable of ensuring high ionic conductivity by performing a rapid crosslinking polymerization reaction while suppressing the generation of a side reaction at a low temperature. Also, since the gel polymer electrolyte prepared by the present invention contains a small amount of an organic solvent, leakage of the organic solvent may be improved. Thus, if the gel polymer electrolyte of the present invention is used, a lithium secondary battery having improved ionic conductivity, degree of dissociation of a lithium salt, stability, and cell performance may be achieved.

### BRIEF DESCRIPTION OF THE DRAWINGS

The following drawings attached to the specification illustrate preferred examples of the present invention by example, and serve to enable technical concepts of the present invention to be further understood together with detailed description of the invention given below, and therefore the present invention should not be interpreted only with matters in such drawings.

FIG. 1 is Fourier transform infrared (FT-IR) spectra of polycaprolactone triol (PCL triol) and polycaprolactone triacrylate (PCL-Ac);

FIG. 2 is a ¹H nuclear magnetic resonance (NMR) spectrum of polycaprolactone triol (PCL triol);

FIG. 3 is a ¹H NMR spectrum of polycaprolactone triacrylate (PCL-Ac);

FIG. 4 is a ¹H NMR spectrum of a precursor composition of Example 3 before a click reaction;

FIG. 5 is a ¹H NMR spectrum of a gel polymer electrolyte of Example 3 after the click reaction;

FIG. 6 is a ¹H NMR spectrum of a precursor composition of Comparative Example 1 before a radical reaction;

FIG. 7 is a ¹H NMR spectrum of the precursor composition of Comparative Example 1 after the radical reaction;

FIG. 8 is Raman spectra of a gel polymer electrolyte of the present invention obtained according to Experimental Example 3;

FIG. 9 is Raman spectra of a liquid electrolyte obtained according to Experimental Example 3;

FIG. 10 is a graph illustrating free ion ratios of TFSI anions obtained from a gel polymer electrolyte and a liquid electrolyte according to Experimental Example 4;

FIG. 11 is a graph of charge/discharge curves according to cycles of a lithium secondary battery prepared in Example 5;

FIG. 12 is a graph illustrating discharge capacity and efficiency according to cycles of the lithium secondary battery prepared in Example 5;

FIG. 13 is a graph of charge/discharge curves according to cycles of a lithium secondary battery prepared in Comparative Example 8;

FIG. 14 is a graph illustrating discharge capacity and efficiency according to cycles of the lithium secondary battery prepared in Comparative Example 8;

FIG. 15 is a graph of discharge curves according to C-rates of a lithium secondary battery according to Experimental Example 6; and

FIG. 16 is a graph of discharge capacity according to C-rates of the lithium secondary battery according to Experimental Example 6.

### MODE FOR CARRYING OUT THE INVENTION

Hereinafter, the present invention will be described in more detail.

Before describing the present invention, it will be further understood that the terms “include,” “comprise,” or “have” in this specification specify the presence of stated features, numbers, steps, elements, or combinations thereof, but do not preclude the presence or addition of one or more other features, numbers, steps, elements, or combinations thereof.

In the present specification, the expression “%” denotes wt % unless explicitly stated otherwise.

Also, the expressions “a” and “b” in the description of “a to b carbon atoms” in the specification each denote the number of carbon atoms included in a specific functional group. That is, the functional group may include “a” to “b” carbon atoms. For example, the expression “alkylene group having 1 to 5 carbon atoms” denotes an alkylene group including 1 to 5 carbon atoms, that is, —CH₂—, —CH₂CH₂—, —CH₂CH₂CH₂—, —CH(CH₃)CH₂—, —CH₂(CH₃)CH—, and —CH(CH₃)CH₂CH₂—.

Furthermore, in the present specification, the expression “alkylene group” denotes a branched or unbranched divalent unsaturated hydrocarbon group. In an embodiment, the alkylene group may be substituted or unsubstituted. The alkylene group includes a methylene group, an ethylene group, a propylene group, an isopropylene group, a butylene group, an isobutylene group, a tert-butylene group, a pentylene group, and 3-pentylene group, but the alkylene group is not limited thereto, and each thereof may be optionally substituted in another exemplary embodiment.

Also, unless otherwise specified in the present invention, the expression “*” denotes the same or different atom or a portion connected between ends of a formula.

Precursor Composition for Polymer Electrolyte

The present invention provides a precursor composition for a polymer electrolyte for preparing a polymer electrolyte.

The precursor composition for a polymer electrolyte of the present invention may include:

a first crosslinking agent formed of a compound containing at least two thiol groups (—SH),

a second crosslinking agent including a compound represented by Formula 2, and

a non-aqueous electrolyte solution containing a lithium salt and an organic solvent.

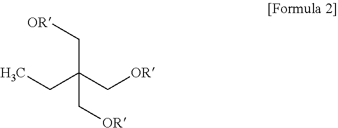

In Formula 2,

R′ is

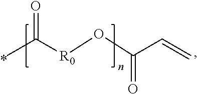

wherein R₀ is an alkylene group having 2 to 8 carbon atoms, and

n is an integer of 1 to 15.

(1) First Crosslinking Agent

First, the first crosslinking agent will be described as follows.

The first crosslinking agent may be formed of a compound containing at least two thiol groups (—SH), and the compound may be a compound represented by the following Formula 1.

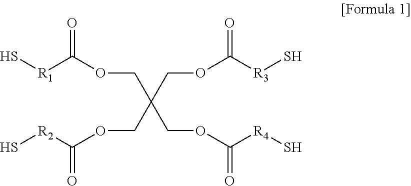

In Formula 1,

R₁ to R₄ are each independently an alkylene group having 1 to 5 carbon atoms.

Since the compound represented by Formula 1 contains at least two thiol groups (—SH) in its structure, it induces a rapid crosslinking reaction with a compound or polymer having three or more reactive groups, i.e., a carbon-carbon double bond structure, such as a vinyl group or an alkene group, at a low temperature, and thus, it may form a three-dimensional crosslinked structure while suppressing the generation of a side reaction. Therefore, since a gel polymer electrolyte capable of ensuring high ionic conductivity in the presence of a small amount of an organic solvent may be prepared, a problem of organic solvent leakage may be improved.

More specifically, the compound represented by Formula 1 may be a compound represented by Formula 1-1 below.

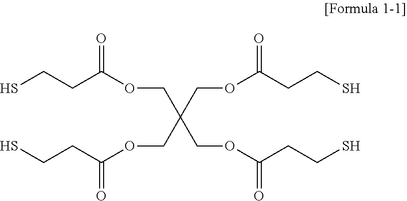 [SMILES: O=C(CCS)OCC(COC(=O)CCS)(COC(=O)CCS)COC(=O)CCS]

(2) Second Crosslinking Agent

Also, the second crosslinking agent will be described as follows.

The second crosslinking agent is not particularly limited as long as it is a compound including at least two polymerizable reactive groups, but a representative example thereof may include a compound represented by the following Formula 2.

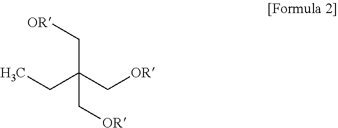

In Formula 2,

R′ is

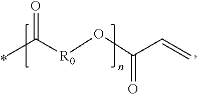

wherein R₀ is an alkylene group having 2 to 8 carbon atoms, and

n is an integer of 1 to 15.

In Formula 2, R₀ may be an alkylene group having 3 to 6 carbon atoms.

Specifically, the compound represented by Formula 2 may be polycaprolactone triacrylate.

Since the compound represented by Formula 2 includes three crosslinkable polymerizable reactive groups, such as a vinyl group or a carbon-carbon double bond group, at its end, it may easily form a crosslink with a crosslinking material having various functional groups as a crosslinking agent during a thiol-ene click reaction. Also, since the compound represented by Formula 2 contains a polar ester unit as a repeating unit in a main chain structure, it may dissociate a lithium salt and may have high chain flexibility, and thus, it may easily conduct Li⁺ ions. Therefore, a polymer electrolyte including a polymer network, which is formed by using the same, may ensure high ionic conductivity even when a small amount of the organic solvent is included.

Particularly, the compound represented by Formula 2, which is included as the second crosslinking agent in the present invention, has lower viscosity than a compound including four polymerizable reactive groups, for example, pentaerythritol tetraacrylate (PET4A). Thus, with respect to the precursor composition for a polymer electrolyte including the compound represented by Formula 2, since reactivity is activated even when a total amount of the crosslinking agents is small as mobility of reactants is increased due to the low viscosity, a polymer network having high ionic conductivity and flexibility network may be formed. As described above, when the compound represented by Formula 2 of the present invention is used, a polymer matrix having improved ionic conductivity and interfacial properties in comparison to the pentaerythritol tetraacrylate may be obtained.

The compound represented by Formula 2 may be synthesized by a condensation reaction of a triol compound represented by Formula 3 with acryloyl chloride using triethylamine in the presence of a catalyst (see Reaction Formula 1 below).

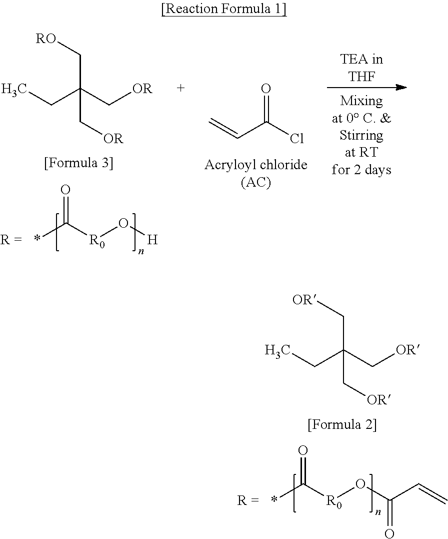

In Formula 3,

R₀ is an alkylene group having 2 to 8 carbon atoms, and n is an integer of 1 to 15.

The total amount of the first crosslinking agent and the second crosslinking agent may be in a range of 3 wt % to 23 wt % based on a total weight of the precursor composition for a polymer electrolyte.

When the total amount of the first and second crosslinking agents is included in the above range, a polymer matrix having mechanical strength and ionic conductivity ensured may be easily formed by easily performing a thiol-ene click reaction to be described later. Specifically, the total amount of the first crosslinking agent and the second crosslinking agent may be in a range of 4 wt % to 20 wt %, for example, 5 wt % to 19 wt %.

When the total amount of the first crosslinking agent and the second crosslinking agent is 23 wt % or less, an increase in interfacial resistance and restriction of movement of lithium ions due to an excessive amount of the compound, for example, a problem caused by a decrease in ionic conductivity may be suppressed, and wettability of the polymer electrolyte may be improved while ensuring proper viscosity. Also, when the total amount of the first crosslinking agent and the second crosslinking agent is 3 wt % or more, a sufficient crosslinked structure may be formed to ensure mechanical properties of the gel polymer electrolyte which are desired to be achieved, and, accordingly, electrolyte solution leakage may be prevented.

Furthermore, a mixing ratio of the first crosslinking agent to the second crosslinking agent in the precursor composition for a polymer electrolyte of the present invention may be calculated in consideration of the number of moles between the reactive functional groups. For example, the polymerizable reactive group of the second crosslinking agent, that is, a terminal acrylate group may be included in an amount of 0.5 moles to 2 moles, for example, 0.8 moles to 1.5 moles based on 1 mole of the thiol group of the first crosslinking agent.

When a molar ratio of the polymerizable reactive group of the second crosslinking agent to the thiol group of the first crosslinking agent is within the above range, since a crosslink may be formed by the thiol-ene click reaction to be described later, a polymer matrix (network) having mechanical strength and ionic conductivity ensured may be easily prepared.

If the molar ratio of the polymerizable reactive group of the second crosslinking agent to the thiol group of the first crosslinking agent is greater than or is outside the above range, since the unreacted first crosslinking agent and/or second crosslinking agent remain after the crosslinking reaction to cause a side reaction to reduce electrochemical stability or are decomposed on a surface of the electrode to form a thick film to increase interfacial resistance, a reduction in capacity of the secondary battery may occur.

(3) Non-Aqueous Electrolyte Solution

Also, the precursor composition for a polymer electrolyte of the present invention may include a non-aqueous electrolyte solution containing a lithium salt and an organic solvent.

(3-1) Lithium Salt

First, the lithium salt will be described as follows.

Various lithium salts typically used in an electrolyte for a lithium secondary battery may be used as the lithium salt included in the non-aqueous electrolyte solution without limitation. For example, the lithium salt may include Li⁺ as a cation, and may include at least one selected from the group consisting of F⁻, Cl⁻, Br⁻, I⁻, NO₃⁻, N(CN)₂⁻, BF₄⁻, ClO₄⁻, AlO₄⁻, AlCl₄⁻, PF₆⁻, SbF₆⁻, AsF₆⁻, B₁₀Cl₁₀⁻, BF₂C₂O₄⁻, BC₄O₈⁻, PF₄C₂O₄⁻, PF₂C₄O₈⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, C₄F₉SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, CH₃SO₃⁻, CF₃(CF₂)₇SO₃⁻, CF₃CO₂⁻, CH₃CO₂⁻, SCN⁻, and (CF₃CF₂SO₂)₂N⁻ as an anion.

Specifically, the lithium salt may include at least one selected from the group consisting of LiCl, LiBr, LiI, LiBF₄, LiClO₄, LiAlO₄, LiAlCl₄, LiPF₆, LiSbF₆, LiAsF₆, LiB₁₀Cl₁₀, LiBOB (LiB(C₂O₄)₂), LiCF₃SO₃, LiTFSI (LiN(SO₂CF₃)₂), LiFSI (LiN(SO₂F)₂), LiCH₃SO₃, LiCF₃CO₂, LiCH₃CO₂, and LiBETI (LiN(SO₂CF₂CF₃)₂). Specifically, the lithium salt may include a single material selected from the group consisting of LiBF₄, LiClO₄, LiPF₆, LiBOB (LiB(C₂O₄)₂), LiCF₃SO₃, LiTFSI (LiN(SO₂CF₃)₂), LiFSI (LiN(SO₂F)₂), and LiBETI (LiN(SO₂CF₂CF₃)₂, or a mixture of two or more thereof.

The lithium salt may be appropriately changed in a normally usable range, but may be included in an amount of 30 wt % to 60 wt %, for example, 42 wt % to 54 wt % based on the total weight of the precursor composition to obtain an optimum effect of forming a film for preventing corrosion of the surface of the electrode.

If the amount of the lithium salt is outside the above concentration range, oxidation stability is reduced due to an increase in organic solvent that is not bonded with Li⁺ ions and an effect of improving low-temperature output and cycle characteristics during high-temperature storage of a lithium secondary battery is insignificant, or impregnability of the electrolyte may be reduced due to an increase in viscosity of the electrolyte.

(3-2) Organic Solvent

Also, an organic solvent will be described as follows.

Various organic solvents typically used in a lithium electrolyte may be used as the organic solvent without limitation. For example, the organic solvent may include a cyclic carbonate-based organic solvent, a linear carbonate-based organic solvent, or a mixed organic solvent thereof.

The cyclic carbonate-based organic solvent is a highly viscous organic solvent which may well dissociate the lithium salt in the electrolyte due to high permittivity, wherein specific examples of the cyclic carbonate-based organic solvent may be at least one organic solvent selected from the group consisting of ethylene carbonate (EC), propylene carbonate (PC), 1,2-butylene carbonate, 2,3-butylene carbonate, 1,2-pentylene carbonate, 2,3-pentylene carbonate, and vinylene carbonate, and, among them, the cyclic carbonate-based organic solvent may include ethylene carbonate.

Also, the linear carbonate-based organic solvent is an organic solvent having low viscosity and low permittivity, wherein typical examples of the linear carbonate-based organic solvent may be at least one organic solvent selected from the group consisting of dimethyl carbonate (DMC), diethyl carbonate (DEC), dipropyl carbonate, ethyl methyl carbonate (EMC), methylpropyl carbonate, and ethylpropyl carbonate, and the linear carbonate-based organic solvent may specifically include ethyl methyl carbonate (EMC).

In the present invention, a mixed organic solvent of the cyclic carbonate-based organic solvent and the linear carbonate-based organic solvent may be included, and, in this case, a mixing ratio of the cyclic carbonate-based organic solvent to the linear carbonate-based organic solvent may be a volume ratio of 10:90 to 80:20, for example, 50:50 to 70:30.

When the volume ratio of the cyclic carbonate-based organic solvent to the linear carbonate-based organic solvent satisfies the above range, a non-aqueous electrolyte solution having higher electrical conductivity may be prepared.

Furthermore, the non-aqueous electrolyte solution of the present invention may further include a linear ester-based organic solvent and/or a cyclic ester-based organic solvent, which has relatively higher stability during high-temperature and high-voltage operation than the cyclic carbonate-based organic solvent, to prepare a non-aqueous electrolyte solution having higher ionic conductivity.

Specific examples of the linear ester-based organic solvent may be at least one organic solvent selected from the group consisting of methyl acetate, ethyl acetate, propyl acetate, methyl propionate, ethyl propionate, propyl propionate, and butyl propionate.

Also, as the cyclic ester-based organic solvent, any one selected from the group consisting of γ-butyrolactone, γ-valerolactone, γ-caprolactone, σ-valerolactone, and ε-caprolactone or a mixture of two or more thereof may be used, but the cyclic ester-based organic solvent is not limited thereto.

The organic solvent may be used by adding an organic solvent typically used in an electrolyte solution for a lithium secondary battery without limitation, if necessary. For example, the organic solvent may further include at least one organic solvent selected from an ether-based organic solvent, an amide-based organic solvent, and a nitrile-based organic solvent.

In the total weight of the precursor composition for a polymer electrolyte of the present invention, the remainder except for the amounts of other components other than the organic solvent, for example, the first crosslinking agent, the second crosslinking agent, the lithium salt, a polymerization initiator to be described later, and other additives optionally included, is the organic solvent unless otherwise specified.

(4) Polymerization Initiator

The precursor composition for a polymer electrolyte of the present invention may further include a polymerization initiator.

A conventional thermal polymerization initiator known in the art may be used as the polymerization initiator. Specifically, the polymerization initiator may include at least one selected from the group consisting of diisobutyl peroxide, t-amylperoxydicarbonate, di(4-tert-butylcyclohexyl)peroxydicarbonate, diethylhexyl peroxydicarbonate, dibutyl peroxydicarbonate, diisopropyl peroxydicarbonate, dicetyl peroxydicarbonate, dimyristyl peroxydicarbonate, tert-butyl peroxypivalate, dilauroyl peroxide, didecanoyl peroxide, 2,5-dimethyl-2,5-di(2-ethylhexanoylperoxy)hexane, 1,1,3,3-tetramethylbutylperoxy-2-ethylhexanoate, tert-amylperoxy-2-ethylhexanoate, dibenzoyl peroxide, t-butylperoxy-2-ethylhexanoate, tert-butylperoxy ethyl acetate, tert-butylperoxy isobutylate, and 1,4-di(tert-butylperoxy carbo)cyclohexane, and the polymerization initiator is specifically a liquid thermal initiator having a low initiation temperature and may include tert-butyl peroxypivalate which generates less gas during an initiation reaction.

The polymerization initiator may be easily dissolved in the organic solvent and may be decomposed by heat at 30° C. to 50° C. to form a radical. A polymer matrix (network) having mechanical strength and ionic conductivity ensured may be formed without the generation of gas while a crosslink is formed between the first crosslinking agent and the second crosslinking agent by the thiol-ene click reaction by the radical thus formed.

The polymerization initiator may be included in an amount of 0.01 part by weight to 20 parts by weight, for example, 0.1 part by weight to 10 parts by weight based on 100 parts by weight of the second crosslinking agent.

When the polymerization initiator is included within the above range, gel polymer electrolyte properties may be secured by increasing a gel polymer conversion rate, and wetting of the electrolyte solution with respect to the electrode may be improved by preventing a pre-gel reaction.

(5) Other Additives

Also, the precursor composition for a polymer electrolyte of the present invention may further include other additives which may form a more stable ion conductive film on the surface of the electrode, if necessary, in order to further improve low-temperature high rate discharge characteristics, high-temperature stability, overcharge prevention, and an effect of improving swelling during high-temperature storage.

Representative examples of the other additive may be at least one first additive selected from the group consisting of a sultone-based compound, a halogen-substituted carbonate-based compound, a nitrile-based compound, a cyclic carbonate-based compound, a sulfite-based compound, a sulfone-based compound, a sulfate-based compound, a phosphate-based or phosphite-based compound, a borate-based compound, and a lithium salt-based compound.

The sultone-based compound may include at least one compound selected from the group consisting of 1,3-propane sultone (PS), 1,4-butane sultone, ethane sultone, 1,3-propene sultone (PRS), 1,4-butene sultone, and 1-methyl-1,3-propene sultone, and may be included in an amount of 5 wt % or less based on the total weight of the precursor composition for a polymer electrolyte. In a case in which the amount of the sultone-based compound in the precursor composition for a polymer electrolyte is greater than 5 wt %, an increase in resistance and a degradation of output may occur due to the formation of an excessively thick film on the surface of the electrode, and the resistance may be increased due to the excessive amount of the additive in the precursor composition for a polymer electrolyte to degrade output characteristics.

Also, the halogen-substituted carbonate-based compound may include fluoroethylene carbonate (FEC), and may be included in an amount of 5 wt % or less based on the total weight of the precursor composition for a polymer electrolyte. In a case in which the amount of the halogen-substituted carbonate-based compound in the precursor composition for a polymer electrolyte is greater than 5 wt %, cell swelling inhibition performance may be degraded.

Furthermore, the nitrile-based compound may include at least one compound selected from the group consisting of succinonitrile (SN), adiponitrile (Adn), acetonitrile, propionitrile, butyronitrile, valeronitrile, caprylonitrile, heptanenitrile, cyclopentane carbonitrile, cyclohexane carbonitrile, 2-fluorobenzonitrile, 4-fluorobenzonitrile, difluorobenzonitrile, trifluorobenzonitrile, phenylacetonitrile, 2-fluorophenylacetonitrile, and 4-fluorophenylacetonitrile.

The nitrile-based compound may be included in an amount of 8 wt % or less based on the total weight of the precursor composition for a polymer electrolyte. In a case in which the total amount of the nitrile-based compound in the precursor composition for a polymer electrolyte is greater than 8 wt %, since the resistance is increased due to an increase in the film formed on the surface of the electrode, battery performance may be degraded.

Also, the cyclic carbonate-based compound may include vinylene carbonate (VC) or vinyl ethylene carbonate, and may be included in an amount of 5 wt % or less based on the total weight of the precursor composition for a polymer electrolyte. In a case in which the amount of the cyclic carbonate-based compound in the precursor composition for a polymer electrolyte is greater than 5 wt %, the cell swelling inhibition performance may be degraded.

The sulfite-based compound may include at least one compound selected from the group consisting of ethylene sulfite, methylethylene sulfite, ethylethylene sulfite, 4,5-dimethylethylene sulfite, 4,5-diethylethylene sulfite, propylene sulfite, 4,5-dimethylpropylene sulfite, 4,5-diethylpropylene sulfite, 4,6-dimethylpropylene sulfite, 4,6-diethylpropylene sulfite, and 1,3-butylene glycol sulfite, and may be included in an amount of 5 wt % or less based on the total weight of the precursor composition.

The sulfone-based compound may include at least one compound selected from the group consisting of divinyl sulfone, dimethyl sulfone, diethyl sulfone, methylethyl sulfone, and methylvinyl sulfone, and may be included in an amount of 5 wt % or less based on the total weight of the precursor composition.

The sulfate-based compound may include ethylene sulfate (Esa), trimethylene sulfate (TMS), or methyl trimethylene sulfate (MTMS), and may be included in an amount of 5 wt % or less based on the total weight of the precursor composition.

The phosphate-based or phosphite-based compound may include at least one compound selected from the group consisting of lithium difluoro bis(oxalato)phosphate, lithium difluorophosphate, tris(trimethylsilyl)phosphate (TMSPa), tris(trimethylsilyl)phosphite (TMSPi), tris(2,2,2-trifluoroethyl)phosphate (TFEPa), and tris(trifluoroethyl)phosphite (TFEPi), and may be included in an amount of 3 wt % or less based on the total weight of the precursor composition for a polymer electrolyte.

The borate-based compound may include tetraphenylborate, lithium oxalyldifluoroborate (LiODFB), or lithium bis(oxalato)borate (LiB(C₂O₄)₂, LiBOB), and may be included in an amount of 3 wt % or less based on the total weight of the precursor composition for a polymer electrolyte.

The lithium salt-based compound is a compound different from the lithium salt included in the precursor composition, wherein the lithium salt-based compound may include LiPO₂F₂ or LiBF₄, and may be included in an amount of 3 wt % or less based on the total weight of the precursor composition for a polymer electrolyte.

Specifically, the halogen-substituted carbonate-based compound, that is, fluoroethylene carbonate (FEC) may be used as the other additive.

Furthermore, two or more other additives may be mixed and included, and a total amount of the other additives included may be 20 wt % or less based on the total weight of the precursor composition for a polymer electrolyte. If the amount of the additives is greater than 20 wt %, there is not only a possibility that a side reaction in the precursor composition for a polymer electrolyte occurs excessively during charge and discharge of the battery, but also, since the additives may not be sufficiently decomposed at high temperatures, the additives may be present in the form of an unreacted material or precipitates in the precursor composition for a polymer electrolyte at room temperature, and, accordingly, life or resistance characteristics of the secondary battery may be degraded.

Gel Polymer Electrolyte

Next, the gel polymer electrolyte according to the present invention will be described.

The gel polymer electrolyte of the present invention may include a polymer matrix (network) which is formed by chemical crosslinking of the first crosslinking agent including at least two thiol groups (—SH) and the second crosslinking agent including one or more polymerizable reactive groups.

The chemical crosslinking may be formed by the thiol-ene click reaction between the first crosslinking agent and the second crosslinking agent, which are included in the precursor composition for a polymer electrolyte, under a low temperature condition.

In order to secure mechanical and thermal stability in a conventional lithium secondary battery, a polymer electrolyte formed by performing a chemical crosslinking reaction using a polyolefin-based polymer and a crosslinking agent was used. However, in order to perform the chemical crosslinking reaction, since strong energy, such as high temperature or ultraviolet light, is not only required, but also an unreacted material remaining without crosslinking may cause a side reaction in the polymer electrolyte or may inhibit the movement of ions to significantly reduce ionic conductivity of the polymer electrolyte, there is a disadvantage in that it adversely affects cell characteristics.

Accordingly, the present invention aims at providing a gel polymer electrolyte in which stability is improved by applying a thiol-ene click chemical reaction which may easily and rapidly crosslink only a specific functional group at a low temperature.

The thiol-ene click reaction is known as a reaction in which various molecules may be easily synthesized with very high selectivity and efficiency under simple reaction conditions and there is little occurrence of side reactions at the same time, wherein it is advantageous in that a crosslinking agent having various functional groups may be used.

Specifically, in the present invention, a polymer network may be easily formed under a low temperature (energy) condition of 50° C. to 80° C. and a pressure condition of 1 MPa or more by reacting the first crosslinking agent having at least two thiol groups with the second crosslinking agent including one or more polymerizable reactive groups.

More specifically, the thiol-ene click reaction may be performed by the steps of:

(a) preparing a precursor composition for a polymer electrolyte by adding a first crosslinking agent, a second crosslinking agent, and a polymerization initiator to a non-aqueous electrolyte solution;

(b) performing a thiol-ene click crosslinking reaction while stirring the precursor composition for a polymer electrolyte at 50° C. to 80° C. for 1 hour to 40 hours; and

(c) terminating the reaction by cooling the precursor composition for a polymer electrolyte to −10° C. to 5° C., after completion of the crosslinking reaction.

The thiol-ene click crosslinking reaction may be performed under a pressure condition of 1 MPa or more.

Also, the thiol-ene click reaction of the present invention may further include a step of (d) purifying a synthesized by-product present in a mixed solution by adding one or more nonsolvents selected from the group consisting of water or an alcohol having 1 to 3 carbon atoms to the precursor composition for a polymer electrolyte, after the termination of the crosslinking reaction.

Lithium Secondary Battery

Furthermore, according to the present invention, a lithium secondary battery including the above-described gel polymer electrolyte of the present invention may be provided.

The lithium secondary battery of the present invention may be prepared according to a conventional method known in the art, and may include a positive electrode including a positive electrode active material, a negative electrode including a negative electrode active material, a separator disposed between the positive electrode and the negative electrode, and the above-described polymer electrolyte.

Specifically, after an electrode assembly is prepared by disposing a porous separator between the positive electrode and the negative electrode, the lithium secondary battery may be prepared by putting the assembled electrode assembly and injecting the precursor composition for a polymer electrolyte of the present invention into a battery case, and performing a thiol-ene click reaction. All of those conventionally used in the preparation of a lithium secondary battery may be used as the positive electrode, negative electrode, and separator which constitute the electrode assembly.

(1) Positive Electrode

First, the positive electrode may be prepared by forming a positive electrode material mixture layer on a positive electrode collector. The positive electrode material mixture layer may be prepared by coating the positive electrode collector with a positive electrode slurry including a positive electrode active material, a binder, a conductive agent, and a solvent, and then drying and rolling the coated positive electrode collector.

The positive electrode collector is not particularly limited so long as it has conductivity without causing adverse chemical changes in the battery, and, for example, stainless steel, aluminum, nickel, titanium, fired carbon, or aluminum or stainless steel that is surface-treated with one of carbon, nickel, titanium, silver, or the like may be used.

The positive electrode active material is a compound capable of reversibly intercalating and deintercalating lithium, wherein the positive electrode active material may specifically include a lithium composite metal oxide including lithium and at least one metal such as cobalt, manganese, nickel, or aluminum. More specifically, the lithium composite metal oxide may include lithium-manganese-based oxide (e.g., LiMnO₂, LiMn₂O₄, etc.), lithium-cobalt-based oxide (e.g., LiCoO₂, etc.), lithium-nickel-based oxide (e.g., LiNiO₂, etc.), lithium-nickel-manganese-based oxide (e.g., LiNi_{1-Y}Mn_{Y}O₂ (where 0<Y<1), LiMn_{2-Z}Ni_{z}O₄ (where 0<Z<2), etc.), lithium-nickel-cobalt-based oxide (e.g., LiNi_{1-Y1}Co_{Y1}O₂ (where 0<Y1<1), etc.), lithium-manganese-cobalt-based oxide (e.g., LiCo_{1-Y2}Mn_{Y2}O₂ (where 0<Y2<1), LiMn_{2-Z1}Co_{z1}O₄ (where 0<Z1<2), etc.), lithium-nickel-manganese-cobalt-based oxide (e.g., Li(NiₚCo_{q}Mnᵣ₁)O₂ (where 0<p<1, 0<q<1, 0<r1<1, and p+q+r1=1) or Li (Niₚ₁Co_{q1}Mnᵣ₂)O₄ (where 0<p1<2, 0<q1<2, 0<r2<2, and p1+q1+r2=2), etc.), or lithium-nickel-cobalt-transition metal (M) oxide (e.g., Li (Niₚ₂Co_{q2}Mnᵣ₃M_{S2})O₂ (where M is selected from the group consisting of aluminum (Al), iron (Fe), vanadium (V), chromium (Cr), titanium (Ti), tantalum (Ta), magnesium (Mg), and molybdenum (Mo), and p2, q2, r3, and s2 are atomic fractions of each independent elements, wherein 0<p2<1, 0<q2<1, 0<r3<1, 0<S2<1, and p2+q2+r3+S2=1), etc.), and any one thereof or a compound of two or more thereof may be included.

Among these materials, in terms of the improvement of capacity characteristics and stability of the battery, the lithium composite metal oxide may include LiCoO₂, LiMnO₂, LiNiO₂, lithium nickel manganese cobalt oxide (e.g., Li(Ni_{1/3}Mn_{1/3}Co_{1/3})O₂, Li(Ni_{0.6}Mn_{0.2}Co_{0.2})O₂, Li(Ni_{0.5}Mn_{0.3}Co_{0.2})O₂, Li (Ni_{0.7}Mn_{0.15}Co_{0.15})O₂, and Li(Ni_{0.8}Mn_{0.1}Co_{0.1})O₂), or lithium nickel cobalt aluminum oxide (e.g., LiNi_{0.8}Co_{0.15}Al_{0.05}O₂, etc.).

The positive electrode active material may be included in an amount of 80 wt % to 99 wt % based on a total weight of solid content in the positive electrode slurry.

The binder is a component that assists in the binding between the active material and the conductive agent and in the binding with the current collector, wherein the binder is commonly added in an amount of 1 wt % to 30 wt % based on the total weight of the solid content in the positive electrode slurry. Examples of the binder may be a fluorine resin-based binder including polyvinylidene fluoride (PVDF) or polytetrafluoroethylene (PTFE); a rubber-based binder including a styrene-butadiene rubber (SBR), an acrylonitrile-butadiene rubber, or a styrene-isoprene rubber; a cellulose-based binder including carboxymethylcellulose (CMC), starch, hydroxypropylcellulose, or regenerated cellulose; a polyalcohol-based binder such as polyvinyl alcohol; a polyolefin-based binder including polyethylene or polypropylene; a polyimide-based binder; a polyester-based binder; and a silane-based binder.

The conductive agent is commonly added in an amount of 1 wt % to 30 wt % based on the total weight of the solid content in the positive electrode slurry.

The conductive agent is not particularly limited as long as it has conductivity without causing adverse chemical changes in the battery, and, for example, a conductive material, such as: carbon powder such as carbon black, acetylene black, Ketjen black, channel black, furnace black, lamp black, or thermal black; graphite powder such as natural graphite with a well-developed crystal structure, artificial graphite, or graphite; conductive fibers such as carbon fibers or metal fibers; conductive powder such as fluorocarbon powder, aluminum powder, and nickel powder; conductive whiskers such as zinc oxide whiskers and potassium titanate whiskers; conductive metal oxide such as titanium oxide; or polyphenylene derivatives, may be used.

The solvent may include an organic solvent, such as N-methyl-2-pyrrolidone (NMP), and may be used in an amount such that desirable viscosity is obtained when the positive electrode active material as well as optionally the binder and the conductive agent are included. For example, the solvent may be included in an amount such that a concentration of the solid content in the slurry including the positive electrode active material as well as optionally the binder and the conductive agent is in a range of 50 wt % to 95 wt %, for example, 70 wt % to 90 wt %.

(2) Negative Electrode

Also, the negative electrode may be prepared by forming a negative electrode material mixture layer on a negative electrode collector. The negative electrode material mixture layer may be formed by coating the negative electrode collector with a slurry including a negative electrode active material, a binder, a conductive agent, and a solvent, and then drying and rolling the coated negative electrode collector.

The negative electrode collector generally has a thickness of 3 μm to 500 μm. The negative electrode collector is not particularly limited so long as it has high conductivity without causing adverse chemical changes in the battery, and, for example, copper, stainless steel, aluminum, nickel, titanium, fired carbon, copper or stainless steel that is surface-treated with one of carbon, nickel, titanium, silver, or the like, an aluminum-cadmium alloy, or the like may be used. Also, similar to the positive electrode collector, the negative electrode collector may have fine surface roughness to improve bonding strength with the negative electrode active material, and the negative electrode collector may be used in various shapes such as a film, a sheet, a foil, a net, a porous body, a foam body, a non-woven fabric body, and the like.

Furthermore, the negative electrode active material may include at least one selected from the group consisting of lithium metal, a carbon material capable of reversibly intercalating/deintercalating lithium ions, metal or an alloy of lithium and the metal, a metal composite oxide, a material which may be doped and undoped with lithium, and a transition metal oxide.

As the carbon material capable of reversibly intercalating/deintercalating lithium ions, a carbon-based negative electrode active material generally used in a lithium ion secondary battery may be used without particular limitation, and, as a typical example, crystalline carbon, amorphous carbon, or both thereof may be used. Examples of the crystalline carbon may be graphite such as irregular, planar, flaky, spherical, or fibrous natural graphite or artificial graphite, and examples of the amorphous carbon may be soft carbon (low-temperature sintered carbon) or hard carbon, mesophase pitch carbide, and fired cokes.

One selected from the group consisting of PbO, PbO₂, Pb₂O₃, Pb₃O₄, Sb₂O₃, Sb₂O₄, Sb₂O₅, GeO, GeO₂, Bi₂O₃, Bi₂O₄, Bi₂O₅, LiₓFe₂O₃ (0≤x≤1), LiₓWO₂ (0≤x≤1), and SnₓMe₁₋ₓMe′_{y}O_{z} (Me: manganese (Mn), Fe, lead (Pb), or germanium (Ge); Me′: Al, boron (B), phosphorus (P), silicon (Si), Groups I, II and III elements of the periodic table, or halogen; 0<x≤1; 1≤y≤3; 1≤z≤8) may be used as the metal composite oxide.

The material, which may be doped and undoped with lithium, may include Si, SiOₓ (0<x<2), a Si—Y alloy (where Y is an element selected from the group consisting of alkali metal, alkaline earth metal, a Group 13 element, a Group 14 element, transition metal, a rare earth element, and a combination thereof, and is not Si), Sn, SnO₂, and Sn—Y (where Y is an element selected from the group consisting of alkali metal, alkaline earth metal, a Group 13 element, a Group 14 element, transition metal, a rare earth element, and a combination thereof, and is not Sn), and a mixture of SiO₂ and at least one thereof may also be used. The element Y may be selected from the group consisting of Mg, calcium (Ca), strontium (Sr), barium (Ba), radium (Ra), scandium (Sc), yttrium (Y), Ti, zirconium (Zr), hafnium (Hf), rutherfordium (Rf), V, niobium (Nb), Ta, dubnium (db), Cr, Mo, tungsten (W), seaborgium (Sg), technetium (Tc), rhenium (Re), bohrium (Bh), Fe, Pb, ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), B, Al, gallium (Ga), tin (Sn), indium (In), Ge, P, arsenic (As), antimony (Sb), bismuth (Bi), sulfur (S), selenium (Se), tellurium (Te), polonium (Po), and a combination thereof.

The transition metal oxide may include lithium-containing titanium composite oxide (LTO), vanadium oxide, and lithium vanadium oxide.

The negative electrode active material may be included in an amount of 80 wt % to 99 wt % based on a total weight of solid content in the negative electrode slurry.

The binder is a component that improves the adhesion between the negative electrode active material particles and the adhesion between the negative electrode active material and a current collector, wherein the binder is commonly added in an amount of 1 wt % to 30 wt % based on the total weight of the solid content in the negative electrode slurry. Examples of the binder may be a fluorine resin-based binder including polyvinylidene fluoride (PVDF) or polytetrafluoroethylene (PTFE); a rubber-based binder including a styrene-butadiene rubber (SBR), an acrylonitrile-butadiene rubber, or a styrene-isoprene rubber; a cellulose-based binder including carboxymethylcellulose (CMC), starch, hydroxypropylcellulose, or regenerated cellulose; a polyalcohol-based binder such as polyvinyl alcohol; a polyolefin-based binder including polyethylene or polypropylene; a polyimide-based binder; a polyester-based binder; and a silane-based binder.

The conductive agent is a component for further improving the conductivity of the negative electrode active material, wherein the conductive agent may be added in an amount of 1 wt % to 20 wt % based on the total weight of the solid content in the negative electrode slurry. One, which is the same as or different from the conductive agent used during the preparation of the positive electrode, may be used as the conductive agent, and, for example, a conductive material, such as: carbon powder such as carbon black, acetylene black, Ketjen black, channel black, furnace black, lamp black, or thermal black; graphite powder such as natural graphite with a well-developed crystal structure, artificial graphite, or graphite; conductive fibers such as carbon fibers or metal fibers; conductive powder such as fluorocarbon powder, aluminum powder, and nickel powder; conductive whiskers such as zinc oxide whiskers and potassium titanate whiskers; conductive metal oxide such as titanium oxide; or polyphenylene derivatives, may be used as the conductive agent.

The solvent may include water or an organic solvent, such as NMP and alcohol, and may be used in an amount such that desirable viscosity is obtained when the negative electrode active material as well as optionally the binder and the conductive agent are included. For example, the solvent may be included in an amount such that a concentration of the solid content including the negative electrode active material as well as optionally the binder and the conductive agent is in a range of 50 wt % to 95 wt %, for example, 70 wt % to 90 wt %.

(3) Separator

Also, the separator plays a role in blocking an internal short circuit between both electrodes and impregnating the electrolyte, wherein, after mixing a polymer resin, a filler, and a solvent to prepare a separator composition, the separator composition is directly coated on the electrode and dried to form a separator film, or, after the separator composition is cast on a support and dried, the separator may be prepared by laminating a separator film peeled from the support on the electrode.

A typically used porous polymer film, for example, a porous polymer film prepared from a polyolefin-based polymer, such as an ethylene homopolymer, a propylene homopolymer, an ethylene/butene copolymer, an ethylene/hexene copolymer, and an ethylene/methacrylate copolymer, may be used alone or in a lamination therewith as the separator. Also, a typical porous nonwoven fabric, for example, a nonwoven fabric formed of high melting point glass fibers or polyethylene terephthalate fibers may be used, but the present invention is not limited thereto.

In this case, the porous separator may generally have a pore diameter of 0.01 μm to 50 μm and a porosity of 5% to 95%. Also, the porous separator may generally have a thickness of 5 μm to 300 μm.

A shape of the lithium secondary battery of the present invention is not particularly limited, but a cylindrical type using a can, a prismatic type, a pouch type, or a coin type may be used.

### EXAMPLES

Hereinafter, the present invention will be described in more detail according to examples. However, the invention may be embodied in many different forms and should not be construed as being limited to the embodiments set forth herein. Rather, these example embodiments are provided so that this description will be thorough and complete, and will fully convey the scope of the present invention to those skilled in the art.

### PREPARATION EXAMPLE

### Preparation Example 1. Polycaprolactone Triacrylate (PCL-Ac) Synthesis

Polycaprolactone triol (number-average molecular weight (Mn)=900, CAS Number 37625-56-2, manufactured by Sigma Aldrich) was vacuum dried at 50° C. for 12 hours.

Then, 10.0 g of the polycaprolactone triol (0.0111 mol) and 3.62 g of acrylochloride (manufactured by Sigma Aldrich, 0.04 mol) were dissolved in 94.6 ml of a tetrahydrofuran (manufactured by Sigma Aldrich) solvent, and was then put into a double jacketed glass reactor.

4.05 g of triethylamine (0.04 mol), as a catalyst, was further added to the reactant at 0° C., and then stirred at 25° C. for 48 hours.

After completion of the reaction, the tetrahydrofuran solvent was removed by vacuum drying, and phase separation was then performed using water and a diethyl ether solvent to primarily remove by-products. Anhydrous magnesium sulfate (DAEJUNG Chemicals and Metals, Co. Ltd.) was added to the extracted solution and stirred to remove remaining water.

Then, magnesium sulfate was removed by filtration, and the solution was vacuum dried at 60° C. to remove diethyl ether.

Then, pure polycaprolactone triacrylate (PCL-Ac) (number-average molecular weight (Mn)=1062, n=6.8) was obtained (yield: 85%) by completely removing unreacted material and side reactant by passing through a chromatography column using methyl chloroform (2.0% methanol).

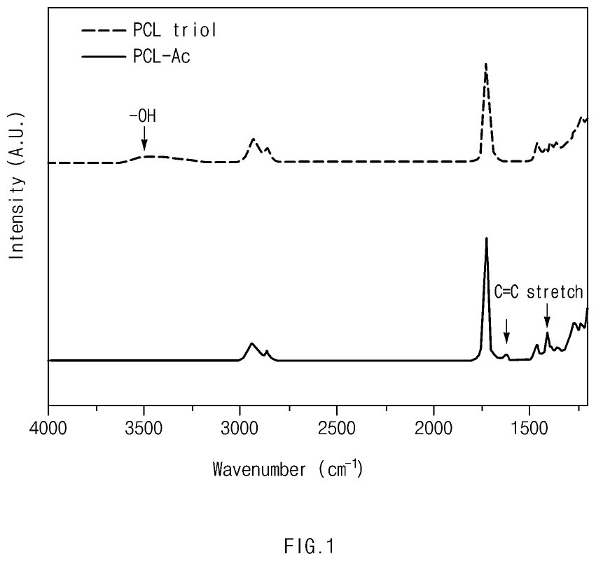

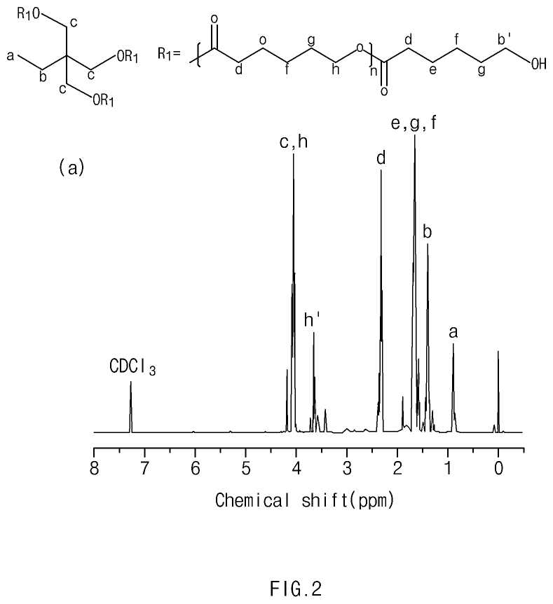

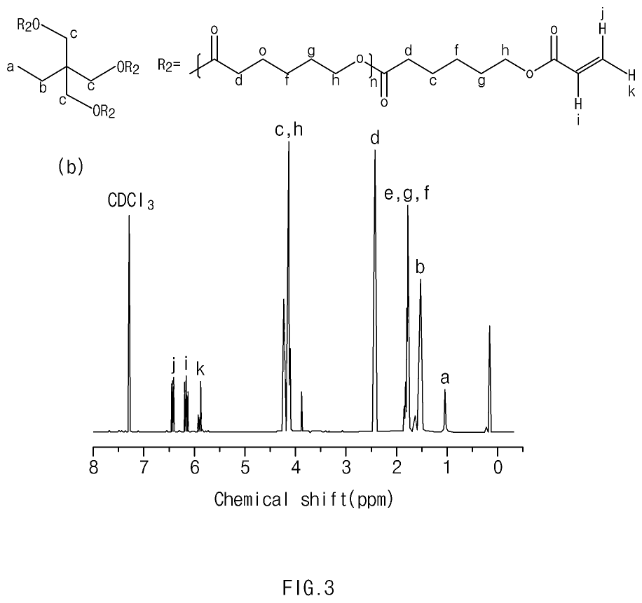

In this case, whether the polycaprolactone triacrylate (PCL-Ac) was synthesized and purified or not was confirmed by attenuated total reflection-Fourier transform infrared (ATR-FTIR) spectra (Nicolet iS50 spectrometer/400 to 4000 cm⁻¹) of FIG. 1 and ¹H NMR spectra (Agilent Technologies, VNMRS 600 MHz) of FIGS. 2 and 3.

Referring to FT-IR spectra of FIG. 1, that polycaprolactone triol reacted with acryloyl chloride to synthesize polycaprolactone triacrylate (PCL-Ac) may be confirmed from the fact that a characteristic peak of —OH group (about 3500 cm⁻¹) disappeared, and characteristic peaks of double bond (C═C) (1300 cm⁻¹ to 1700 cm⁻¹) appeared.

Also, referring to ¹H NMR spectrum results of FIGS. 2 and 3, that polycaprolactone triol reacted with acryloyl chloride to synthesize polycaprolactone triacrylate (PCL-Ac) may be confirmed from the fact that characteristic peaks (3.4 ppm to 3.7 ppm) of —CH₂OH group of the polycaprolactone triol (PCL triol) disappeared as illustrated in FIG. 2, and characteristic peaks (5.7 ppm to 6.5 ppm) of acrylate group (—CO—CH═CH₂) at an end of the polycaprolactone triacrylate (PCL-Ac) appeared as illustrated in FIG. 3.

### EXAMPLES

### I. Gel Polymer Electrolyte Preparation

### Example 1

A precursor composition for a polymer electrolyte was prepared by adding 0.446 g (4.46 wt %) of the polycaprolactone triacrylate prepared in Preparation Example 1, as a second crosslinking agent, 0.154 g (1.54 wt %) of pentaerythritol tetrakis(3-mercapto propionate) (PETMP, Sigma-Aldrich) (thiol group:carbon-carbon double bond group=1:1 molar ratio), as a first crosslinking agent, and 0.004 g of tert-butylperoxy pivalate (t-BPP, Arkema Inc.) (1 part by weight relative to the amount of the polycaprolactone triacrylate), as a polymerization initiator, to a non-aqueous electrolyte solution (3.996 g) composed of dimethyl carbonate (PANAX ETEC CO. LTD) in which 5.4 g (54 wt %) of LiTFSI was dissolved (see Table 1 below).

Then, while stirring the precursor composition for a polymer electrolyte at 70° C. for 3 hours under a pressure condition of 1 MPa or more, a thiol-ene click reaction was performed to prepare a gel polymer electrolyte.

### Example 2

A precursor composition for a polymer electrolyte was prepared by adding 0.892 g (8.92 wt %) of the polycaprolactone triacrylate prepared in Preparation Example 1, as a second crosslinking agent, 0.308 g (3.08 wt %) of pentaerythritol tetrakis(3-mercapto propionate) (PETMP, Sigma-Aldrich) (thiol group:carbon-carbon double bond group=1:1 molar ratio), as a first crosslinking agent, and 0.009 g of tert-butylperoxy pivalate (t-BPP, Arkema Inc.), as a polymerization initiator, to a non-aqueous electrolyte solution (3.991 g) composed of dimethyl carbonate (PANAX ETEC CO. LTD) in which 4.8 g (48 wt %) of LiTFSI was dissolved (see Table 1 below).

Then, while stirring the precursor composition for a polymer electrolyte at 70° C. for 3 hours under a pressure condition of 1 MPa or more, a thiol-ene click reaction was performed to prepare a gel polymer electrolyte.

### Example 3

A precursor composition for a polymer electrolyte was prepared by adding 1.338 g (13.38 wt %) of the polycaprolactone triacrylate prepared in Preparation Example 1, as a second crosslinking agent, 0.462 g (4.62 wt %) of pentaerythritol tetrakis(3-mercapto propionate) (PETMP, Sigma-Aldrich) (thiol group:carbon-carbon double bond group=1:1 molar ratio), as a first crosslinking agent, and 0.013 g of tert-butylperoxy pivalate (t-BPP, Arkema Inc.), as a polymerization initiator, to a non-aqueous electrolyte solution (3.987 g) composed of dimethyl carbonate (PANAX ETEC CO. LTD) in which 4.2 g (42 wt %) of LiTFSI was dissolved (see Table 1 below).

Then, while stirring the precursor composition for a polymer electrolyte at 70° C. for 3 hours under a pressure condition of 1 MPa or more, a thiol-ene click reaction was performed to prepare a gel polymer electrolyte.

### Example 4

A precursor composition for a polymer electrolyte was prepared by adding 0.446 g (4.46 wt %) of the polycaprolactone triacrylate prepared in Preparation Example 1, as a second crosslinking agent, 0.154 g (1.54 wt %) of pentaerythritol tetrakis(3-mercapto propionate) (PETMP, Sigma-Aldrich) (thiol group:carbon-carbon double bond group=1:1 molar ratio), as a first crosslinking agent, 0.5 g (5.0 wt %) of fluorethylene carbonate (FEC), as other additives, and 0.004 g of tert-butylperoxy pivalate (t-BPP, Arkema Inc.), as a polymerization initiator, to a non-aqueous electrolyte solution (3.496 g) composed of dimethyl carbonate (PANAX ETEC CO. LTD) in which 5.4 g (54 wt %) of LiTFSI was dissolved (see Table 1 below).

Then, while stirring the precursor composition for a polymer electrolyte at 70° C. for 3 hours under a pressure condition of 1 MPa or more, a thiol-ene click reaction was performed to prepare a gel polymer electrolyte.

TABLE 1

| | | | Ex- | Ex- | Ex- | Ex- |
|---|---|---|---|---|---|---|
| | | | ample | ample | ample | ample |
| | | | 1 | 2 | 3 | 4 |
| Cross- | First | Amount | 0.154 | 0.308 | 0.462 | 0.154 |
| linking | agent | (g) | | | | |
| agent | cross- | Amount | 1.54 | 3.08 | 4.62 | 1.54 |
| | linking | (%) | | | | |
| | Second | Amount | 0.446 | 0.892 | 1.339 | 0.446 |
| | agent | (g) | | | | |
| | cross- | Amount | 4.46 | 8.92 | 13.38 | 4.46 |
| | linking | (%) | | | | |
| | Total amount of | | 6.0 | 12 | 18 | 6.0 |
| | crosslinking | | | | | |
| | agents (%) | | | | | |
| Non- | Lithium | Amount | 5.40 | 4.80 | 4.20 | 5.40 |
| aqueous | salt | (g) | | | | |
| electro- | | Amount | 54 | 48 | 42 | 54 |
| lyte | | (%) | | | | |
| solution | Solvent | Amount | 4.0 | | | |
| | (DMC) | (g) | | | | |
| | Additive | Amount | — | — | — | 0.5 |
| | (FEC) | (g) | | | | |
| | | Amount | — | — | — | 5.0 |
| | | (%) | | | | |

| | | | | |
|---|---|---|---|---|
| Polymerization initiator | 0.44 | 0.009 | 0.013 | 0.004 |
| amount (g) | | | | |

In Table 1, the abbreviation of each compound has the following meaning.

DMC: Dimethyl carbonate

FEC: Fluoroethylene carbonate

### Comparative Example 1

A precursor composition for a polymer electrolyte was prepared by adding 0.600 g (6 wt %) of the polycaprolactone triacrylate prepared in Preparation Example 1 and 0.006 g of tert-butylperoxy pivalate (t-BPP, Arkema Inc.), as a polymerization initiator, to a non-aqueous electrolyte solution (3.994 g) composed of dimethyl carbonate (PANAX ETEC CO. LTD) in which 5.4 g (54 wt %) of LiTFSI was dissolved (see Table 2 below).

While stirring the precursor composition for a polymer electrolyte at 70° C. for 3 hours under a pressure condition of 1 MPa or more, a gel polymer electrolyte was prepared by a radical reaction.

### Comparative Example 2

A precursor composition for a polymer electrolyte was prepared by adding 0.600 g (6 wt %) of pentaerythritol tetraacrylate (PETTA) and 0.006 g of tert-butylperoxy pivalate (t-BPP, Arkema Inc.), as a polymerization initiator, to a non-aqueous electrolyte solution (3.994 g) composed of dimethyl carbonate (PANAX ETEC CO. LTD) in which 5.4 g (54 wt %) of LiTFSI was dissolved (see Table 2 below).

While stirring the precursor composition for a polymer electrolyte at 70° C. for 3 hours under a pressure condition of 1 MPa or more, a gel polymer electrolyte was prepared by a radical reaction.

### Comparative Example 3

A precursor composition for a polymer electrolyte was prepared by adding 0.349 g (3.49 wt %) of pentaerythritol tetrakis(3-mercapto propionate) (PETMP, Sigma-Aldrich), as a first crosslinking agent, 0.251 g (2.51 wt %) of pentaerythritol tetraacrylate (PETTA) represented by Formula 4 below, 0.5 g (5.0 wt %) of fluorethylene carbonate (FEC), as other additives, and 0.003 g of tert-butylperoxy pivalate (t-BPP, Arkema Inc.), as a polymerization initiator, to a non-aqueous electrolyte solution (3.497 g) composed of dimethyl carbonate (PANAX ETEC CO. LTD) in which 5.4 g (54 wt %) of LiTFSI was dissolved (see Table 2 below), and then stirred at 70° C. for 3 hours under a pressure condition of 1 MPa or more.

However, since the cross-linking reaction did not proceed smoothly as mobility of the reactants was reduced due to high viscosity of the precursor composition for a polymer electrolyte, a gel polymer electrolyte was not formed.

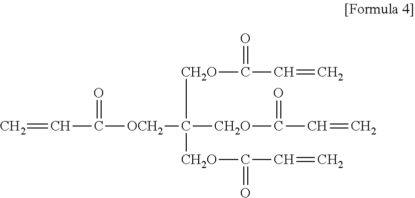

### Comparative Example 4

A precursor composition for a polymer electrolyte was prepared by adding 0.697 g (6.67 wt %) of pentaerythritol tetrakis(3-mercapto propionate) (PETMP, Sigma-Aldrich), as a first crosslinking agent, 0.503 g (5.03 wt %) of pentaerythritol tetraacrylate (PETTA), and 0.005 g of tert-butylperoxy pivalate (t-BPP, Arkema Inc.), as a polymerization initiator, to a non-aqueous electrolyte solution (3.995 g) composed of dimethyl carbonate (PANAX ETEC CO. LTD) in which 4.8 g (48 wt %) of LiTFSI was dissolved (see Table 2 below).

While stirring the precursor composition for a polymer electrolyte at 70° C. for 3 hours under a pressure condition of 1 MPa or more, a gel polymer electrolyte was prepared by a radical reaction.

### Comparative Example 5

A precursor composition for a polymer electrolyte was prepared by adding 0.697 g (6.97 wt %) of pentaerythritol tetrakis(3-mercapto propionate) (PETMP, Sigma-Aldrich), as a first crosslinking agent, 0.503 g (5.03 wt %) of pentaerythritol tetraacrylate (PETTA), and 0.005 g of tert-butylperoxy pivalate (t-BPP, Arkema Inc.), as a polymerization initiator, to a non-aqueous electrolyte solution (3.995 g) composed of dimethyl carbonate (PANAX ETEC CO. LTD) in which 4.8 g (48 wt %) of LiTFSI was dissolved (see Table 2 below).

While stirring the precursor composition for a polymer electrolyte at 70° C. for 3 hours under a pressure condition of 1 MPa or more, a gel polymer electrolyte was prepared by a radical reaction.

### Comparative Example 6

A precursor composition for a polymer electrolyte was prepared by adding 0.149 g (1.49 wt %) of the polycaprolactone triacrylate prepared in Preparation Example 1, as a second crosslinking agent, 0.051 g (0.51 wt %) of pentaerythritol tetrakis(3-mercapto propionate) (PETMP, Sigma-Aldrich) (thiol group:carbon-carbon double bond group=1:1 molar ratio), as a first crosslinking agent, and 0.001 g of tert-butylperoxy pivalate (t-BPP, Arkema Inc.), as a polymerization initiator, to a non-aqueous electrolyte solution (3.999 g) composed of dimethyl carbonate (PANAX ETEC CO. LTD) in which 5.8 g (58 wt %) of LiTFSI was dissolved (see Table 2 below).

The precursor composition for a polymer electrolyte was stirred at 70° C. for 3 hours under a pressure condition of 1 MPa or more.

However, since the crosslinking reaction did not proceed smoothly due to a low total amount of the crosslinking agents in the precursor composition for a polymer electrolyte, a free-standing gel polymer electrolyte was not formed.

### Comparative Example 7

A precursor composition for a polymer electrolyte was prepared by adding 0.1858 g (18.58 wt %) of the polycaprolactone triacrylate prepared in Preparation Example 1, as a second crosslinking agent, 0.642 g (6.42 wt %) of pentaerythritol tetrakis(3-mercapto propionate) (PETMP, Sigma-Aldrich) (1:1 based on the number of moles of functional groups), as a first crosslinking agent, and 0.019 g of tert-butylperoxy pivalate (t-BPP, Arkema Inc.), as a polymerization initiator, to a non-aqueous electrolyte solution (3.981 g) composed of dimethyl carbonate (PANAX ETEC CO. LTD) in which 3.5 g (35 wt %) of LiTFSI was dissolved (see Table 2 below).

Then, while stirring the precursor composition for a polymer electrolyte at 70° C. for 3 hours under a pressure condition of 1 MPa or more, a thiol-ene click reaction was performed to prepare a gel polymer electrolyte.

TABLE 2

| | | | Com- | Com- | Com- | Com- | Com- | Com- | Com- |
|---|---|---|---|---|---|---|---|---|---|
| | | | para- | para- | para- | para- | para- | para- | para- |
| | | | tive | tive | tive | tive | tive | tive | tive |
| | | | Ex- | Ex- | Ex- | Ex- | Ex- | Ex- | Ex- |
| | | | ample | ample | ample | ample | ample | ample | ample |
| | | | 1 | 2 | 3 | 4 | 5 | 6 | 7 |
| Cross- | First | Amount | — | — | 0.349 | 0.697 | 0.697 | 0.051 | 0.642 |
| linking | Cross- | (g) | | | | | | | |
| agent | linking | Amount | — | — | 3.49 | 6.97 | 6.97 | 0.51 | 6.42 |
| | agent | (%) | | | | | | | |
| | Second | Amount | 0.60 | — | — | — | — | 0.149 | 1.858 |
| | Cross- | (g) | | | | | | | |
| | linking | Amount | 6 | — | — | — | — | 1.49 | 18.58 |
| | agent | (%) | | | | | | | |
| | Total amount | | 6.0 | 6.0 | 6.0 | 12 | 12 | 2.0 | 25 |
| | of | | | | | | | | |
| | crosslinking | | | | | | | | |
| | agents (%) | | | | | | | | |
| | PETTA | Amount | — | 0.600 | 0.251 | 0.697 | 0.697 | — | — |
| | | (g) | | | | | | | |
| | | Amount | — | 6 | 2.51 | 6.97 | 6.97 | — | — |
| | | (%) | | | | | | | |
| Non- | Lithium | Amount | 5.4 | 5.4 | 5.4 | 4.8 | 4.8 | 5.80 | 3.50 |
| electro | salt | (g) | | | | | | | |
| lyte | | Amount | 54 | 54 | 54 | 48 | 48 | 58 | 35 |
| aqueous | | (%) | | | | | | | |
| solution | Solvent | Amount | 4.00 | | | | | | |
| | (DMC) | (g) | | | | | | | |
| | Additive | Amount | — | — | 0.5 | — | 0.5 | — | — |
| | (FEC) | (g) | | | | | | | |
| | | Amount | — | — | 5.0 | — | 5.0 | — | — |
| | | (%) | | | | | | | |

| | | | | | | | |
|---|---|---|---|---|---|---|---|
| Polymerization | 0.006 | 0.006 | 0.003 | 0.005 | 0.005 | 0.001 | 0.019 |
| initiator amount(g) | | | | | | | |
| Whether or not a gel | ◯ | ◯ | X | ◯ | ◯ | X | ◯ |
| polymer electrolyte | | | | | | | |
| was obtained | | | | | | | |

In Table 2, the abbreviation of each compound has the following meaning.

DMC: Dimethyl carbonate

FEC: Fluoroethylene carbonate

PETTA: Pentaerythritol tetraacrylate

### II. Secondary Battery Preparation

### Example 5

A positive electrode active material (Li(Ni_{0.6}Mn_{0.2}Co_{0.2})O₂), a conductive agent (carbon black), and a binder (polyvinylidene fluoride) were added to N-methyl-2-pyrrolidone (NMP) in a weight ratio of 97.5:1:1.5 to prepare a positive electrode slurry (solid content: 50 wt %). A 12 μm thick aluminum (Al) thin film, as a positive electrode collector, was coated with the positive electrode slurry, dried, and then roll-pressed to prepare a positive electrode.

Lithium (Li) metal was used as a negative electrode active material.

After an electrode assembly was prepared by sequentially stacking the prepared positive electrode, a polyolefin-based porous separator, and the negative electrode, the assembled electrode assembly was accommodated in a battery case, the precursor composition for a polymer electrolyte prepared in Example 4 was injected thereinto, and a thiol-ene click reaction was then performed, while stirring at 70° C. for 3 hours, to prepare a lithium secondary battery including a gel polymer electrolyte.

### Comparative Example 8

A lithium secondary battery was prepared in the same manner as in Example 5 except that the precursor composition for a polymer electrolyte prepared in Comparative Example 5, instead of the precursor composition for a polymer electrolyte prepared in Example 4, was used to prepare the lithium secondary battery.

### EXPERIMENTAL EXAMPLES

### Experimental Example 1. Evaluation of Degree of Crosslinking (1)

In order to evaluate a degree of crosslinking of the gel polymer electrolyte of Example 3 prepared by using the click reaction, ¹H NMR analysis (Agilent Technologies, VNMRS 600 MHz) was performed.

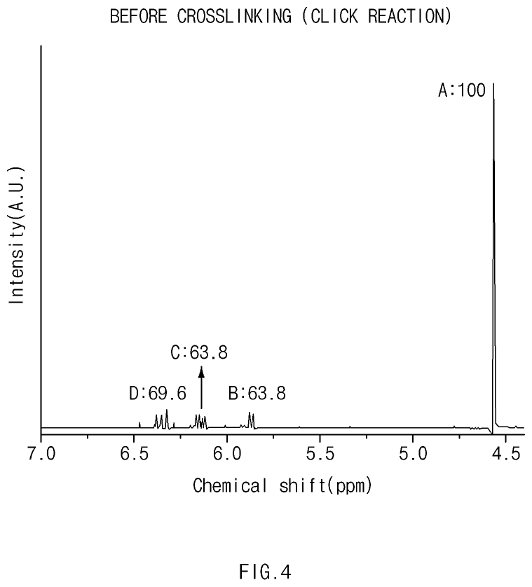

First, in order to measure a change in integral value of acrylate group peak, 0.5 wt % of ethylene carbonate, as an additive that did not form a crosslink, was additionally added to the precursor composition for a polymer electrolyte prepared in Example 3 to prepare a mixed solution. Herein, since the ethylene carbonate was a high boiling point solvent that did not participate in the reaction, it was added as a reference material for comparing an intensity of the acrylate NMR peak participating in the reaction. 0.1 g of the mixed solution was dissolved in 2 g of acetone D6 (manufactured by Merck KGaA), and then loaded into an NMR tube, and an acrylate peak before crosslinking was measured (see FIG. 4).

Then, while stirring the mixed solution at 70° C. for 0.5 hours, a thiol-ene click reaction was performed to prepare a gel polymer electrolyte.

After completion of the reaction, 2 g of acetone D6 (manufactured by Merck KGaA) was added to the prepared gel polymer electrolyte to extract an unreacted material and ethylene carbonate.

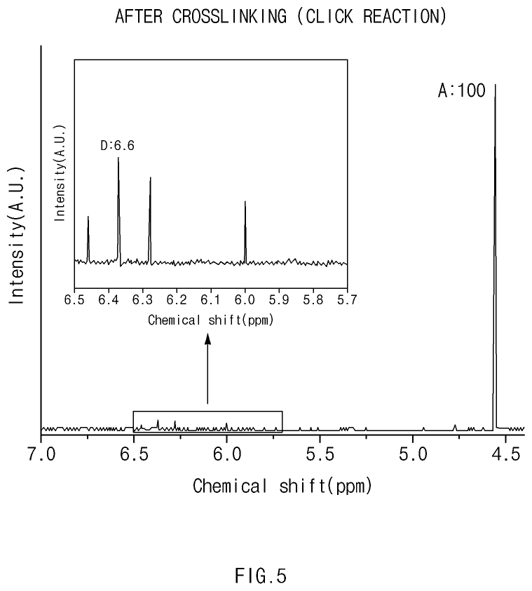

The extracted solution was loaded into an NMR tube, and an acrylate peak after crosslinking was measured. The results thereof are presented in FIG. 5.

Referring to the ¹H NMR results of FIGS. 4 and 5, with respect to the gel polymer electrolyte of Example 3 prepared by using the click reaction, since characteristic peaks (5.7 ppm to 6.5 ppm) of the acrylate group (—CO—CH═CH₂) of the polycaprolactone triacrylate (PCL-Ac) disappeared only within 30 minutes of the crosslinking reaction, it may be understood that a degree of crosslinking of about 96.8% or more was formed.

### Experimental Example 2. Evaluation of Degree of Crosslinking (2)

In order to evaluate a degree of crosslinking of the gel polymer electrolyte of Comparative Example 1 prepared by using the radical polymerization reaction, ¹H NMR analysis (Agilent Technologies, VNMRS 600 MHz) was performed in the same manner as in Experimental Example 2.

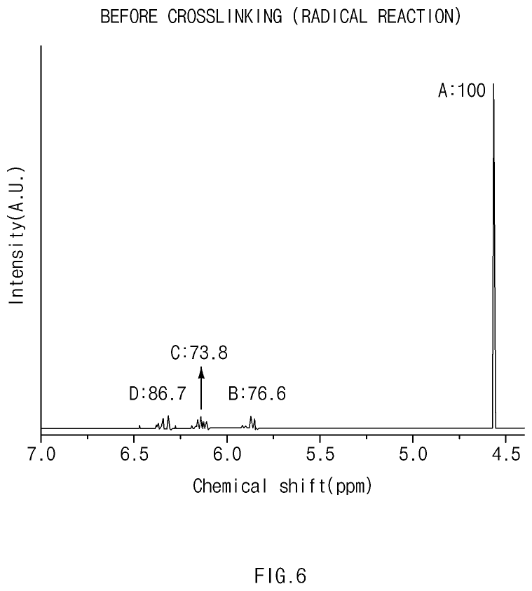

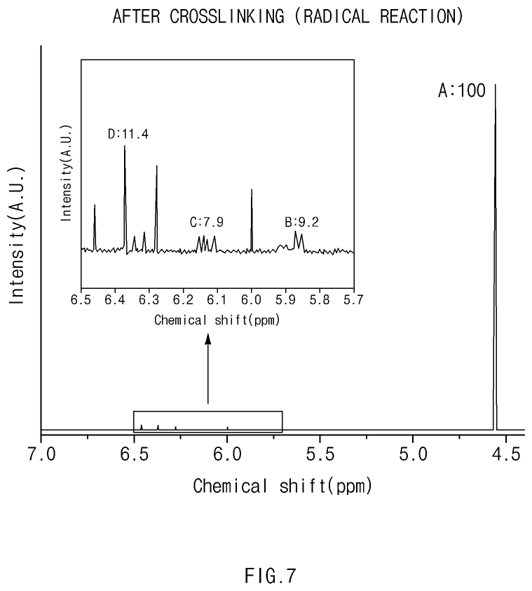

In this case, acrylate peaks before crosslinking before the radical polymerization reaction are illustrated in FIG. 6. Then, acrylate peaks after the radical polymerization reaction are illustrated in FIG. 7.

Referring to the ¹H NMR results of FIGS. 6 and 7, with respect to the gel polymer electrolyte of Comparative Example 1 prepared by using the radical reaction, characteristic peaks (5.7 ppm to 6.5 ppm) of the acrylate group (—CO—CH═CH₂) of the polycaprolactone triacrylate (PCL-Ac) appeared even after 30 minutes of the crosslinking reaction, and it may be understood that a degree of crosslinking of about 88.0% was formed.

Referring to the results of Experimental Examples 2 and 3, it may be understood that the radical reaction under the same environment had a lower crosslinking reaction effect than the click reaction using the precursor composition of the present invention.

### Experimental Example 3. Degree of Dissociation of Lithium Salt (1)

In order to analyze a degree of dissociation of the lithium salt in the gel polymer electrolyte, a precursor composition for a polymer electrolyte was prepared with the same amounts of other components except for changing the concentration of the lithium salt in the precursor composition of Example 1 as in Table 3 below.

Then, while stirring the precursor composition for a polymer electrolyte at 70° C. for 3 hours, a thiol-ene click reaction was performed to prepare gel polymer electrolytes of Examples 1-1 to 1-4.

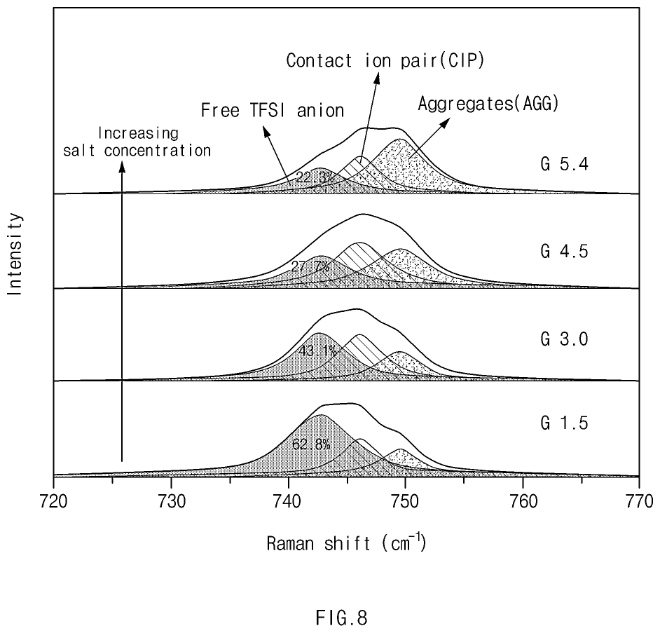

Raman analysis using Raman spectroscopy (LabRAM HR Evolution Raman spectrometer (Horiba Scientific, 785 nm laser source)) was performed on the gel polymer electrolytes of Examples 1-1 to 1-4, and Raman spectra obtained are illustrated in FIG. 8.

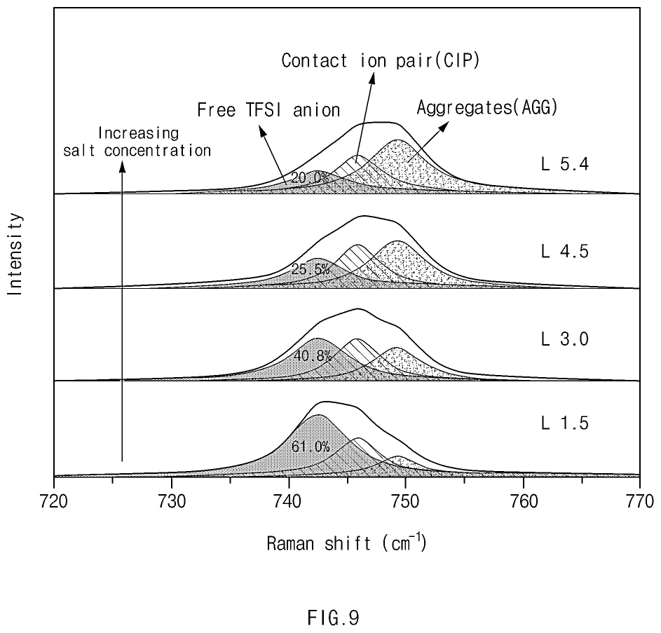

Also, after lithium salts were respectively dissolved in dimethyl carbonate (PANAX ETEC CO. LTD) (4.0 g) at concentrations of 1.5 g (27.3 wt %), 3.0 g (42.9 wt %), 4.5 g (52.9 wt %), and 5.4 g (57.4 wt %) to prepare liquid electrolytes (LE-1 to LE-4), spectral results obtained by performing Raman analysis on the liquid electrolytes are illustrated in FIG. 9.

In this case, a TFSI anion form of the lithium salt was classified into three types such as a free ion (Raman shift: 743 cm⁻¹), a contact ion pair (CIP, Raman shift: 746 cm⁻¹), and an aggregate (AGG, Raman shift: 750 cm⁻¹), and the degree of dissociation of the lithium salt was calculated by comparing an area of each peak.

TABLE 3

| | Lithium salt concentration (g) |
|---|---|
| Example 1-1 | 1.5 |
| Example 1-2 | 3.0 |
| Example 1-3 | 4.5 |
| Example 1-4 | 5.4 |
| LE-1 | 1.5 |
| LE-2 | 3.0 |
| LE-3 | 4.5 |
| LE-4 | 5.4 |

Referring to FIGS. 8 and 9, the peaks observed at 743 cm⁻¹, 746 cm⁻¹, and 750 cm⁻¹ corresponded to CF₃ bending vibrations in the form of the free ion, the contact ion pair (CIP) and the aggregate (AGG) of the TFSI anion, wherein it may be understood that a free ion concentration of the TFSI anion was decreased and an aggregate concentration of the TFSI anion was increased as the concentration of the lithium salt was increased in both the electrolytes of Examples and Comparative Examples. This seems to be because the degree of dissociation was decreased as the concentration of the lithium salt was increased.

### Experimental Example 4. Degree of Dissociation of Lithium Salt (2)

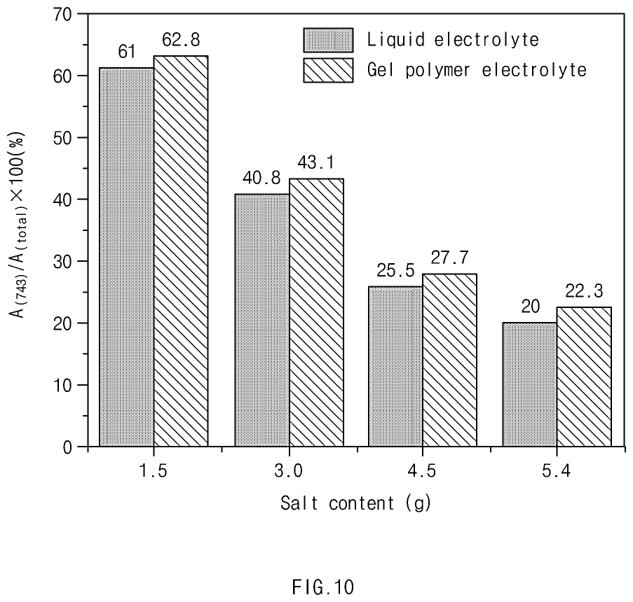

Free ion ratios of the TFSI anions obtained from the liquid electrolytes (LE-1 to LE-4) and the gel polymer electrolytes of Examples 1-1 to 1-4 prepared in Experimental Example 3 are illustrated in FIG. 10.

Referring to FIG. 10, it may be understood that the gel polymer electrolytes of Examples 1-1 to 1-4 exhibited a higher free ion concentration ratio than the liquid electrolytes (LE-1 to LE-4) at all salt concentrations. Accordingly, it may be confirmed that the polycaprolactone triacrylate, which was included as the crosslinking agent in the polymer electrolyte, not only acted as a crosslinking agent for the click chemical reaction, but also participated in generation of more free ions by dissociating the lithium salt, that is, dissolving the lithium salt.

### Experimental Example 5. Cell Evaluation (1)

After an activation (formation) process was performed at 0.1 C rate on each of the lithium secondary batteries prepared in Example 5 and Comparative Example 8, gas in each secondary battery was removed through a degassing process.

A charge and discharge cycle, in which each lithium secondary battery having gas removed therefrom was charged and discharged at 0.2 C rate in a voltage range of 3.0 V to 4.2 V in a constant current manner at room temperature (25° C.) using charge/discharge equipment, was performed 50 times. In this case, PNE-0506 charge/discharge equipment (manufacturer: PNE SOLUTION Co., Ltd.) was used as the charge/discharge equipment used for the charging and discharging of the battery.

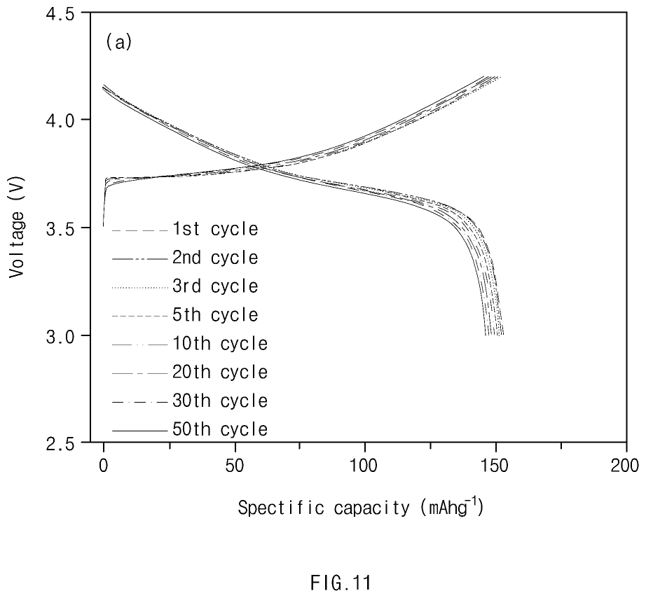

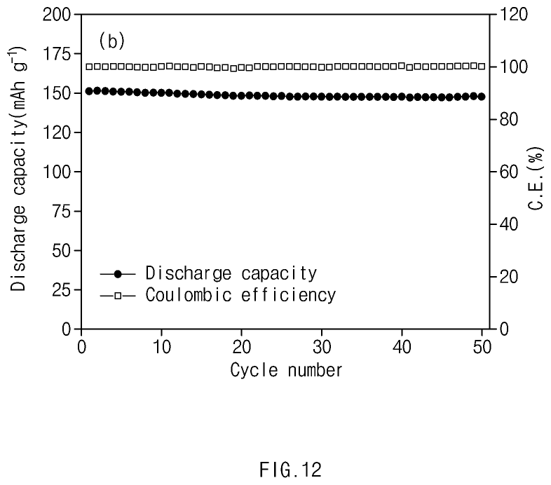

Subsequently, a charge/discharge curve of the secondary battery of Example 5 according to each cycle is illustrated in FIG. 11. Also, discharge capacity efficiency of the secondary battery of Example 5 according to each cycle is illustrated in FIG. 12.

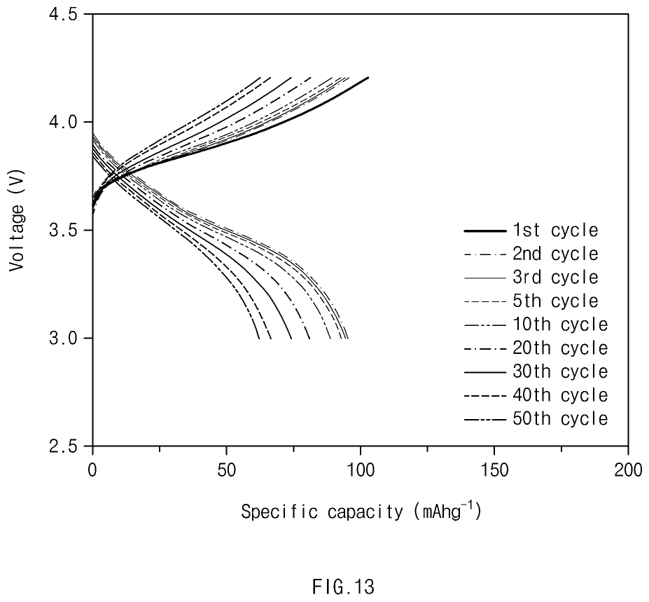

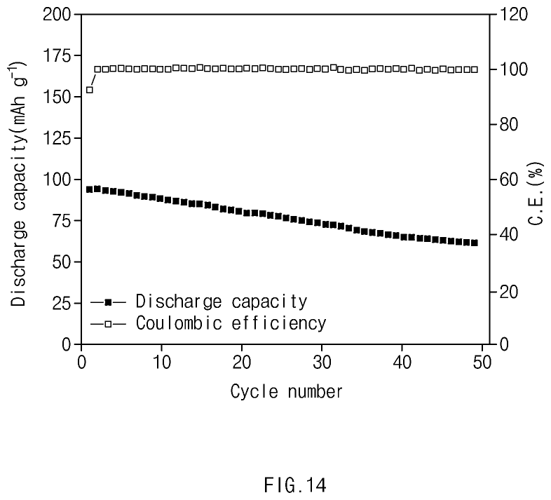

Furthermore, a charge/discharge curve of the secondary battery of Comparative Example 8 according to each cycle is illustrated in FIG. 13. Also, discharge capacity efficiency of the secondary battery of Comparative Example 8 according to each cycle is illustrated in FIG. 14.

Referring to FIGS. 11 and 12, it may be understood that the lithium secondary battery of the present invention was stably charged and discharged up to 50 cycles, and exhibited an excellent capacity retention of 98% relative to initial capacity even immediately after about 50 cycles.

In contrast, referring to FIGS. 13 and 14, it may be understood that the lithium secondary battery of Comparative Example 8 had lower initial capacity than the secondary battery of Example 5, and exhibited a low capacity retention of 65% relative to initial capacity even immediately after 50 cycles.

That is, with respect to the lithium secondary battery of Example 5 of the present invention, it may be understood that significantly improved capacity retention and charge/discharge efficiency were achieved even though the amount of the crosslinking agent for constituting the polymer electrolyte was lower than that of the lithium secondary battery of Comparative Example 8.

### Experimental Example 6. Cell Evaluation (2)

After an activation (formation) process was performed at 0.1 C rate on the lithium secondary battery prepared in Example 5, gas in the secondary battery was removed through a degassing process.

25 cycles of a charge and discharge process, in which charging of each lithium secondary battery having gas removed therefrom at 0.1 C rate to 4.2 V under a constant current condition at room temperature (25° C.), and discharging at 0.1 C rate, 0.2 C rate, 0.5 C rate, and 1.0 C rate to 3.0 V under a constant current condition were set as one cycle, were performed using charge/discharge equipment. In this case, PNE-0506 charge/discharge equipment (manufacturer: PNE SOLUTION Co., Ltd.) was used as the charge/discharge equipment used for the charging and discharging of the battery.

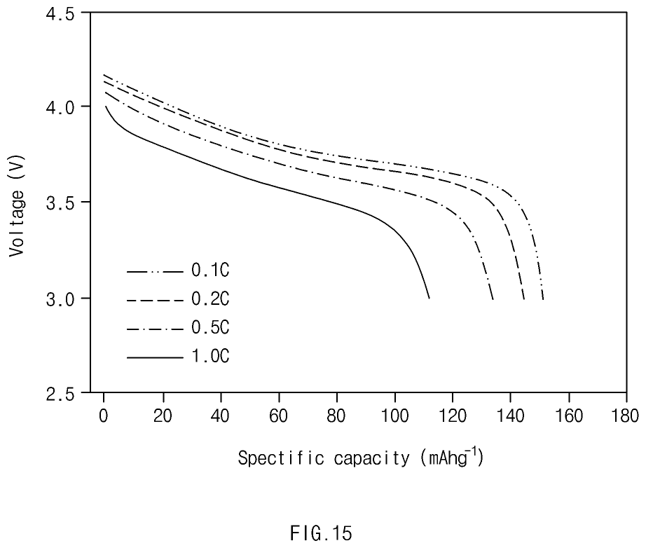

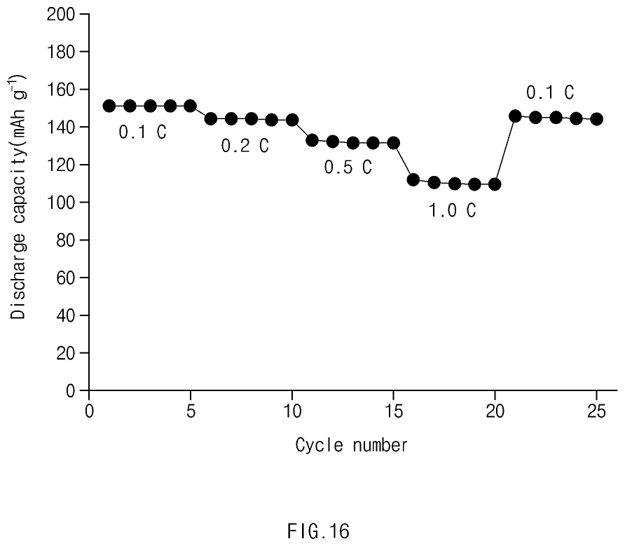

Subsequently, discharge curves obtained at different C rates and discharge capacity according to C rates are illustrated in FIGS. 15 and 16, respectively.

Referring to FIGS. 15 and 16, it may be understood that the lithium secondary battery of the present invention exhibited a capacity of 112 mAh/g at 1.0 C rate, and recovered initial capacity at 0.1 C again.

### Experimental Example 7. Ionic Conductivity Evaluation

Ionic conductivities of the gel polymer electrolytes prepared in Examples 1 to 4 and the gel polymer electrolytes prepared in Comparative Examples 2, 4, and 7 were measured, and the results thereof are presented in Table 4 below. After each precursor composition for a polymer electrolyte was injected into a band-type conductive glass substrate or lithium-copper foil, then polymerized by thermosetting, and sufficiently dried, the ionic conductivity was measured by a method in which an AC impedance between band-type or sandwich-type electrodes was measured in a frequency range of 10 to 106 Hz at an amplitude of 50 mV using a CH instrument (CHI 600D) at 25° C. and 45° C. under an argon atmosphere, and a measured value was analyzed with a frequency response analyzer to interpret the impedance.

TABLE 4

| | Ionic conductivity (S/cm) | |
|---|---|---|
| | 25° C. | 45° C. |
| Example 1 | 2.1 × 10⁻³ | 3.4 × 10⁻³ |
| Example 2 | 2.0 × 10⁻³ | 3.0 × 10⁻³ |
| Example 3 | 1.7 × 10⁻³ | 2.7 × 10⁻³ |
| Example 4 | 2.5 × 10⁻³ | 4.0 × 10⁻³ |
| Comparative Example 2 | 1.6 × 10⁻³ | 2.8 × 10⁻³ |
| Comparative Example 4 | 1.6 × 10⁻³ | 2.7 × 10⁻³ |
| Comparative Example 7 | 6.3 × 10⁻⁴ | 1.1 × 10⁻³ |

Referring to Table 4, it may be understood that ionic conductivities of the gel polymer electrolytes of Examples 1 to 4 were excellent at about 1.7×10⁻³ S/cm or more at 25° C. and at about 2.7×10⁻³ S/cm or more at 45° C.

In contrast, since the gel polymer electrolyte of Comparative Example 2 using pentaerythritol tetraacrylate alone did not include polycaprolactone triacrylate as an ion conductive material, it may be understood that ionic conductivity was reduced in comparison to the gel polymer electrolytes of Examples 1 to 4.

Also, with respect to Comparative Example 4 using 12% pentaerythritol tetraacrylate (PETTA) as the second crosslinking agent, the gel polymer electrolyte was formed, but, since a somewhat large amount of the pentaerythritol tetraacrylate without ionic conductivity was included, it may be understood that it exhibited lower ionic conductivity than the gel polymer electrolytes of Examples 1 to 4.

Furthermore, with respect to the secondary battery of Comparative Example 7 having a high total amount of the crosslinking agents in the precursor composition, since high crosslinking density was formed between the crosslinking agents, it may be understood that it exhibited lower ionic conductivity than the gel polymer electrolytes of Examples 1 to 4.

1. A precursor composition for a polymer electrolyte, comprising:
a first crosslinking agent comprising a compound containing at least two thiol groups (—SH),
a second crosslinking agent including a compound represented by Formula 2, and
a non-aqueous electrolyte solution containing a lithium salt and an organic solvent: 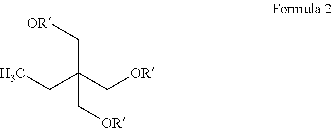
wherein, in Formula 2,
R′ is 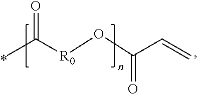
wherein R₀ is an alkylene group having 2 to 8 carbon atoms, and
n is an integer of 1 to 15.

2. The precursor composition for a polymer electrolyte of claim 1, wherein the compound containing at least two thiol groups (—SH) comprises a compound represented by Formula 1: 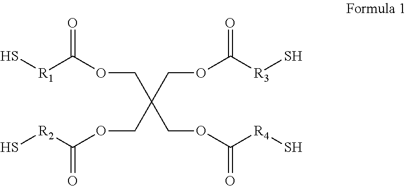
wherein, in Formula 1,
R1 to R4 are each independently an alkylene group having 1 to 5 carbon atoms.

3. The precursor composition for a polymer electrolyte of claim 2, wherein the compound represented by Formula 1 comprises a compound represented by Formula 1-1.

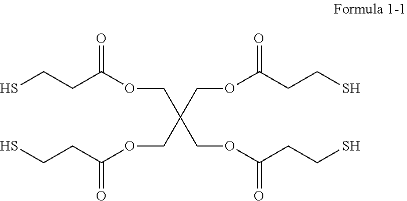 [SMILES: O=C(CCS)OCC(COC(=O)CCS)(COC(=O)CCS)COC(=O)CCS]

4. The precursor composition for a polymer electrolyte of claim 1, wherein, in Formula 2, R₀ is an alkylene group having 3 to 6 carbon atoms.

5. The precursor composition for a polymer electrolyte of claim 1, wherein the compound represented by Formula 2 is polycaprolactone triacrylate.

6. The precursor composition for a polymer electrolyte of claim 1, wherein a total amount of the first crosslinking agent and the second crosslinking agent is in a range of 3 wt % to 23 wt % based on a total weight of the precursor composition for a polymer electrolyte.

7. The precursor composition for a polymer electrolyte of claim 1, wherein a total amount of the first crosslinking agent and the second crosslinking agent is in a range of 4 wt % to 20 wt % based on a total weight of the precursor composition for a polymer electrolyte.

8. The precursor composition for a polymer electrolyte of claim 1, further comprising a polymerization initiator.

9. The precursor composition for a polymer electrolyte of claim 8, wherein the polymerization initiator comprises tert-butyl peroxypivalate.

10. The precursor composition for a polymer electrolyte of claim 8, wherein the polymerization initiator is included in an amount of 0.01 part by weight to 20 parts by weight based on 100 parts by weight of the second crosslinking agent.

11. A gel polymer electrolyte comprising a polymer matrix which is formed by a thiol-ene click reaction of the precursor composition for a polymer electrolyte of claim 1.

12. The gel polymer electrolyte of claim 11, wherein the thiol-ene click reaction is performed at 50° C. to 80° C.

13. A lithium secondary battery comprising the gel polymer electrolyte of claim 11.
